(19) United States
(12) Patent Application Publication
(10) Pub. No.: US 2013/0199402 A1
(43) Pub. Date: Aug. 8, 2013

(54) INFLIGHT CATERING APPARATUS

(71) Applicant: P.A. Mohammed Ansar, New Delhi (IN)

(72) Inventor: P.A. Mohammed Ansar, New Delhi (IN)

(21) Appl. No.: 13/640,484

(22) PCT Filed: Apr. 19, 2011
(86) PCT No.: PCT/IN11/00260

§ 371 Date: Dec. 27, 2012

(30) Foreign Application Priority Data
Apr. 19, 2010 (IN) 934/DEL/2010

(51) Int. Cl. B64D 11/00

(52) U.S. Cl. CPC B64D 11/00
USPC 104/91

(57) ABSTRACT

The present invention discloses a tray cart for serving refreshments in an airplane. The tray cart having: a load bearing railing coupled with a fuselage portion of the airplane, the railing stretching from a first end of the airplane to a second end over an aisle portion of the airplane; and a trolley for carrying the refreshments, the trolley being suspended from the railing by means of one or more suspension wires, the trolley being slidable over the railing by means of one or more geared wheels. The trolley is suspended to a predetermined length above a floor of the aisle portion of the airplane, the suspension length permitting removal of the refreshments placed in the trolley by an attendant without having to bend down.

### FIELD OF INVENTION

The present invention is directed towards improved space utilization in aircrafts. More particularly, the present invention provides an improved catering system for aircrafts.

### BACKGROUND OF THE INVENTION

Air as a mode of travel is gaining popularity as more and more people choose to make their travels by airplane. The airline industry is becoming highly competitive in this scenario and airliners are engaged in the process of providing better facilities to the passengers at reduced prices.

The most critical expenditure for any airline company is the fuel cost which amounts from 30 to 40% of its operating cost. To reduce the fuel consumption airlines try to slash on the payload by amounts as meager as 0.07 ounce an article. While it was only the total luggage weight carried by a passenger that was chargeable earlier, in recent times some airlines are even contemplating charging the passengers's body weight if it exceeds a critical weight limit. Other articles central to the air travel hospitality and leisure, like food/water and reading material are almost constant weight that can't be done away with.

The profitability of an airline operator depends on two thumb rules; reduced payload and enhanced customer satisfaction. In a scenario when the airlines is trying to save fuel cost by cutting down on the material amenities onboard customer satisfaction, which largely depends on the in-flight services are at stake. Once the plane is airborne passengers mostly look forward to the food service to entertain themselves. And compromising on the quality of that service could affect the revenues of the company adversely.

Around the world airliners along with manufacturers and caterers are considering options that could provide the passenger with an enjoyable experience without having to spend much on fuel. The most probable way will be to re engineer the back end processes of air catering logistics and keeping the interface with the passengers in a better way, or at least in the same way.

This is the point when it calls for a critical thinking on the catering system design in the passenger aircraft. A revamp of the entire stretch of logistics from food preparation to packing to transportation and stocking in the flight will have to be modified other than the modifications of the spatial and other material requirement of the process. There are spaces within the aircraft, like the ceiling and the crown space, which has been not taken heed of until now, which has promising prospects for the spatial requirement of redesigning the system. Utilizing them and judiciously realigning the perceptions on in-flight 1 food catering could bring down the payload weight considerable opening up new avenues to enhance in-flight experience for both Cabin crew and the Passengers.

Hence, there is need for an improved space utilization catering apparatus in aircrafts.

### SUMMARY OF THE INVENTION

The present invention discloses a tray cart for serving refreshments in an airplane, the tray cart comprising: a load bearing railing coupled with a fuselage portion of the airplane, the railing stretching from a first end of the airplane to a second end over an aisle portion of the airplane; and a trolley for carrying the refreshments, the trolley being suspended from the railing by means of one or more suspension wires, the trolley being slidable over the railing by means of one or more geared wheels. In an embodiment, the trolley is suspended to a predetermined length above a floor of the aisle portion of the airplane, the suspension length permitting removal of the refreshments placed in the trolley by an attendant without having to bend down.

In an embodiment of the present invention, the trolley is slidable over the railing from the first end of the airplane to the second end and from the second end of the airplane to the first end. In another embodiment, the trolley comprises: at least one locking means for locking the trolley in a desired position on the railing; and a releasing means for releasing the trolley from the locked position. The tray cart further comprises a motor and gear system for enabling sliding of the trolley over the railing, the motor and gear system being concealed within a ceiling of the airplane, the motor and gear system being controlled by controlling means provided on a side of the trolley.

Further in an embodiment, the trolley comprises one or more pneumatic suspension means for retracting the trolley into a storage position in a ceiling of a rear end of the airplane. In another embodiment, the trolley comprises one or more pneumatic suspension means for recovering the trolley from a storage position in a ceiling of the airplane, and one or more shelves for carrying the refreshments. In yet another embodiment, the trolley comprises an audio visual interface and a billing counter, and the trolley comprises means for controlling a speed of sliding of the trolley over the railing.

In an embodiment, the refreshments comprises magazines of prepackaged food and drink, the magazines being designed to fit into the trolley, and the refreshments are loaded onto the trolley by using a conveyor belt and robotic arms.

The aforementioned and other embodiments of the present invention shall be described in greater depth in the drawings and detailed description provided below.

### BRIEF DESCRIPTION OF THE ACCOMPANYING DRAWINGS

The present invention is described by way of embodiments illustrated in the accompanying drawings wherein:

FIG. 1 illustrates a plurality of fuselage designs available in typical aircrafts;

FIG. 2 illustrates an average usable area within the fuselage of a typical aircraft;

FIG. 3 illustrates an average tray cart in the aisle area of a typical aircraft;

FIG. 4 illustrates a tray cart in a newly conceived space and demonstrates the freeing of space in the aisle, in accordance with an embodiment of the present invention;

FIG. 5 illustrates a railing fixed to a fuselage structure, in accordance with an embodiment of the present invention;

FIG. 6 illustrates a cross sectional view of the point of suspension of a trolley from the railing with geared wheels, in accordance with an embodiment of the present invention;

FIG. 7 illustrates a trolley suspended from the railing, in accordance with an embodiment of the present invention;

FIG. 8 illustrates a schematic diagram of the catering apparatus, in accordance with an embodiment of the present invention;

FIG. 9 illustrates a position of a person operating the trolley, in accordance with an embodiment of the present invention;

FIG. 10 illustrates a magazine, in accordance with an embodiment of the present invention;

FIG. 11 illustrates a modular packing, in accordance with an embodiment of the present invention;

FIG. 12 illustrates a lateral stocking method, in accordance with an embodiment of the present invention;

FIG. 13 illustrates an overhead stocking method, in accordance with an embodiment of the present invention; and

FIG. 14 illustrates a mechanism of retracting and folding the apparatus, in accordance with an embodiment of the present invention.

### DETAILED DESCRIPTION OF THE INVENTION

The aim of the present invention is to design a system by which there can be an alternative to the conventional tray cart that will be utilizing the unused space in between the cabin baggage spaces below the ceiling. This primarily focuses on freeing the limited space between the passenger seats on the aisle thus making it convenient for the cabin crew as well as passenger to move about.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

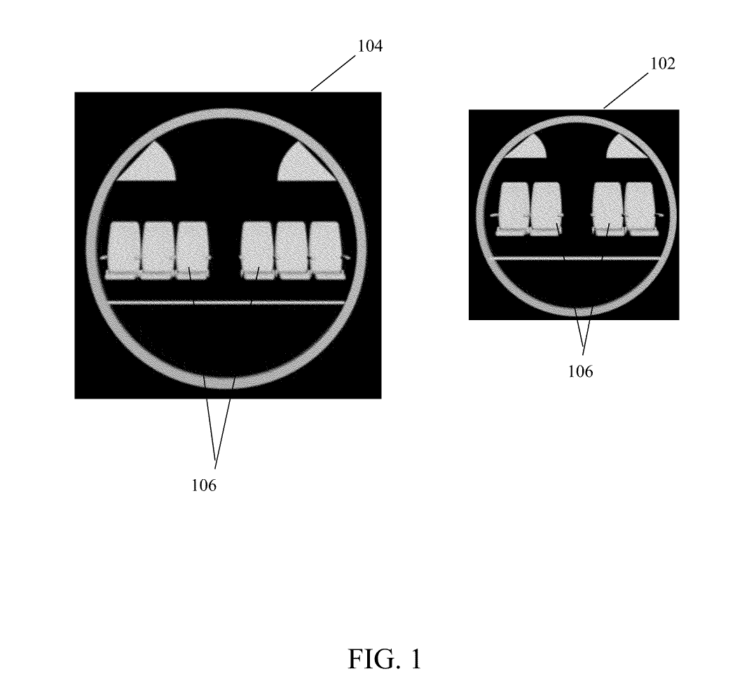

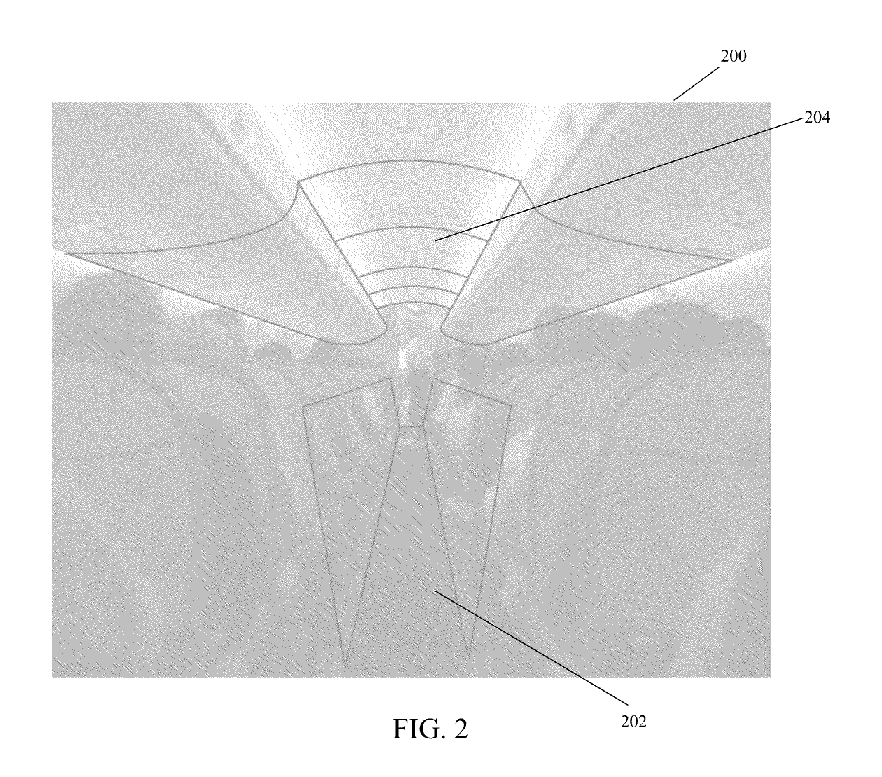

FIG. 1 illustrates a plurality of fuselage designs available in typical aircrafts. The total area available within the fuselage cross section is shown in narrow bodied 102 and wide bodied 104 aircrafts. In both these the areas between the aisle seats 106 are about 2.5 to 3 ft. The usable areas in both are above the seat backrest level. In wide bodied aircrafts 104 there is ample crown space area too which can't be made use of. FIG. 2 illustrates an average usable area within the fuselage of a typical aircraft 200. The space 202 between the seats is less while the space 204 above the seat level is ample and utilizable.

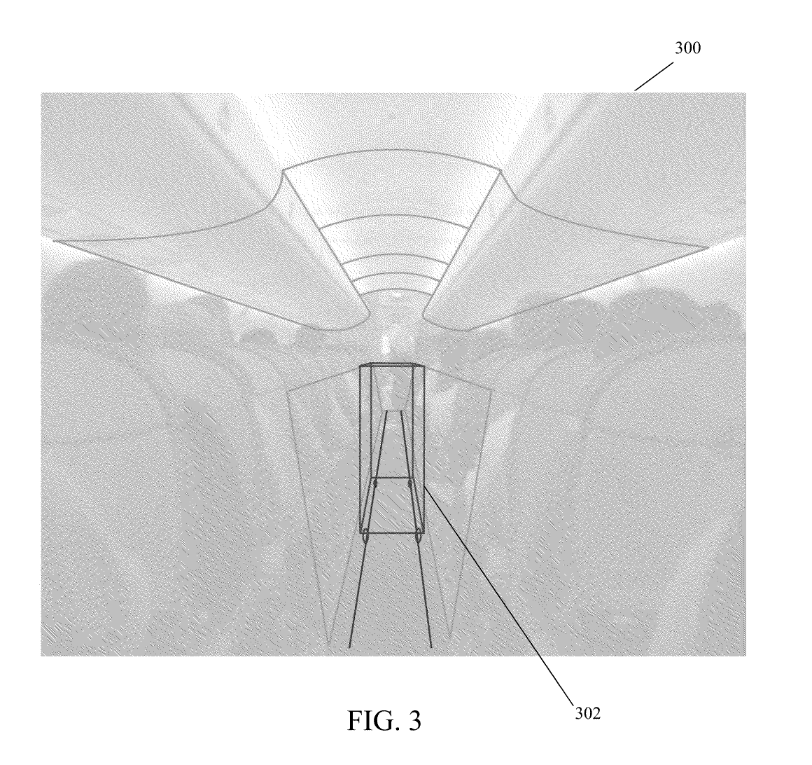

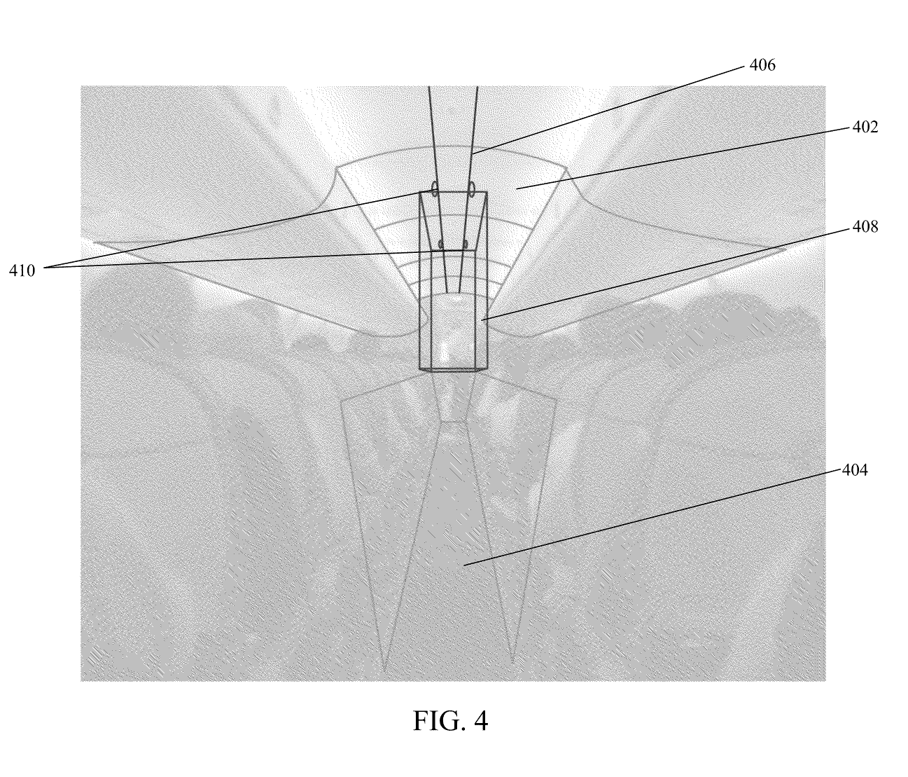

FIG. 3 illustrates an average tray cart 302 in the aisle area of a typical aircraft 300. FIG. 4 illustrates a tray cart in a newly conceived space 402 and demonstrates the freeing of space in the aisle 404, in accordance with an embodiment of the present invention. The tray cart comprises a railing 406 and a trolley 408 for carrying the refreshments required to be served in the aircraft. The trolley 408 is suspended from the railing 406 that is a load bearing structure attached to the fuselage frame of the aircraft. The railing 406 stretches the entire length from and to where the trolley is required to be taken. The suspended trolley 408 comprises geared wheels 410 which enables the trolley 408 to be rolled down the aisle with controls of locking in position and releasing for movement. The tray cart also comprises motor and the gear system for operating the geared wheels 410 which is placed above the ceiling of the aircraft and is hidden from the view from within the cabin space. In an embodiment, a console for the motor and the gear system is provided at a side of the tray cart and is easily accessible by an operating cabin crew member.

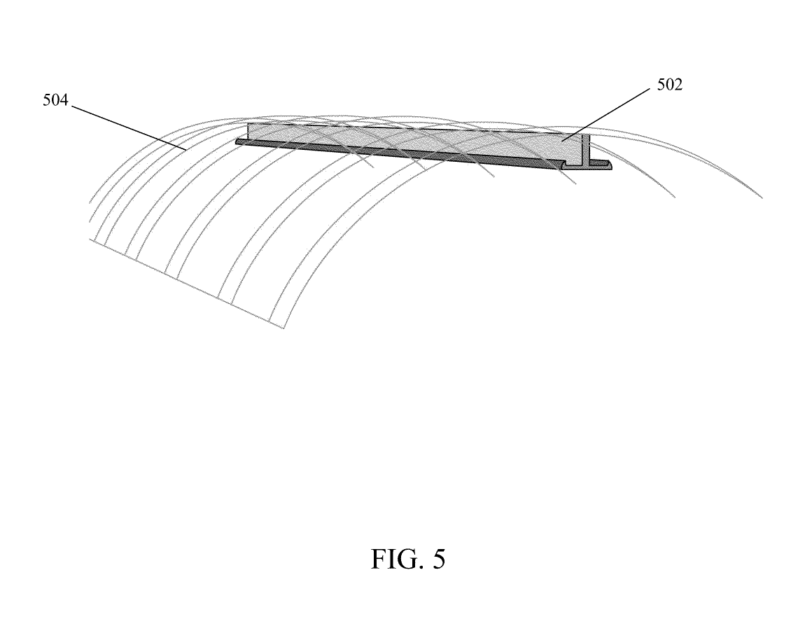

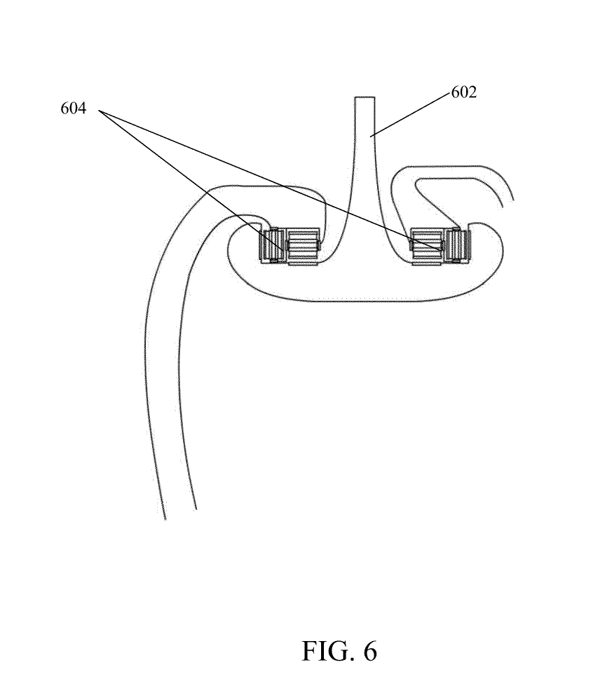

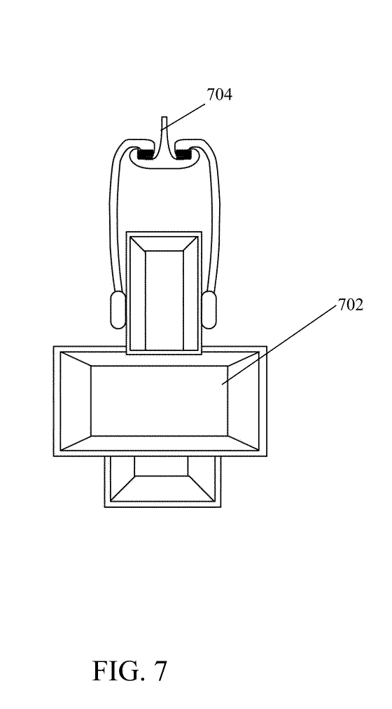

In an embodiment, the suspended trolley 408 retracts into the ceiling at the rear end of the aircraft when it is not being used, and can be pulled down and made ready by loading with preloaded magazines of food. FIG. 5 illustrates a railing 502 fixed to a fuselage structure 504 of the aircraft, in accordance with an embodiment of the present invention. FIG. 6 illustrates a cross sectional view of the point of suspension of a trolley from the railing 602 by using geared wheels 604, in accordance with an embodiment of the present invention. FIG. 7 illustrates a trolley 702 suspended from the railing 704, in accordance with an embodiment of the present invention.

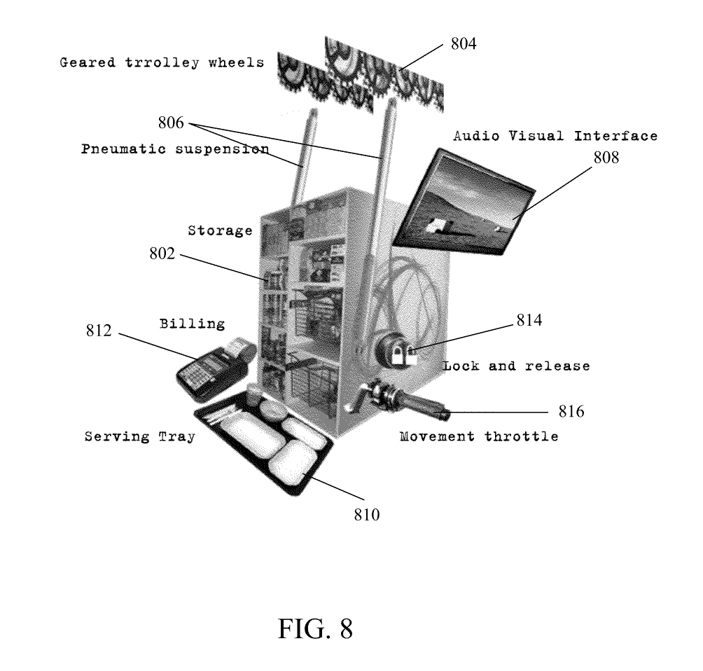

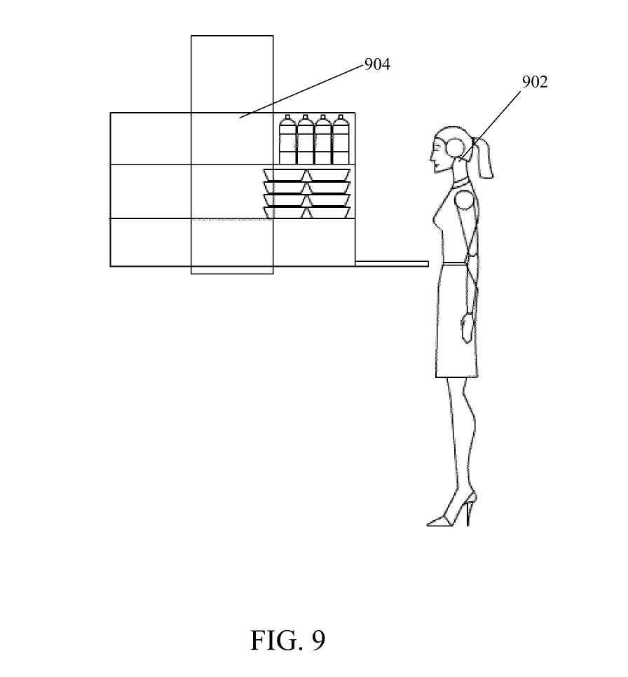

FIG. 8 illustrates a schematic diagram of the tray cart, in accordance with an embodiment of the present invention. As illustrated, the tray cart comprises a trolley 802 for storing refreshments. The trolley 802 comprises geared trolley wheels 804, pneumatic suspensions 806 for retracting and pulling down the trolley 802 from a storage position in a ceiling of the aircraft, audio visual interface 808, serving tray 810 for serving the refreshments, billing counter 812, lock and release console 814 for stopping and starting a sliding movement of the trolley 802, and a movement throttle 816 which may be semi automated or manual. FIG. 9 illustrates a position of a person 902 operating the tray cart 904, in accordance with an embodiment of the present invention. The whole mass and activities will happen above the waist level making the activity ergonomic. Everything within the tray cart 904 is at the eye level and within arms reach of the operating person 902.

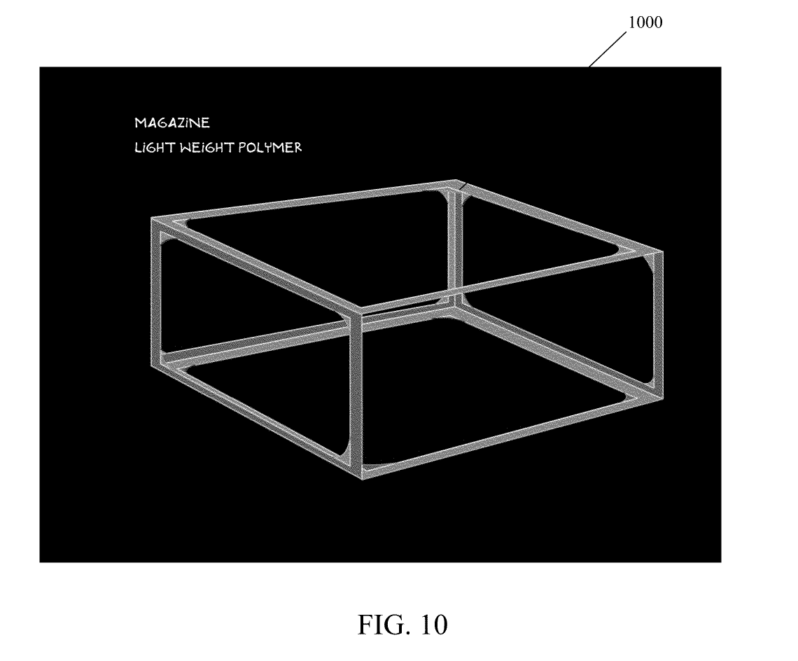

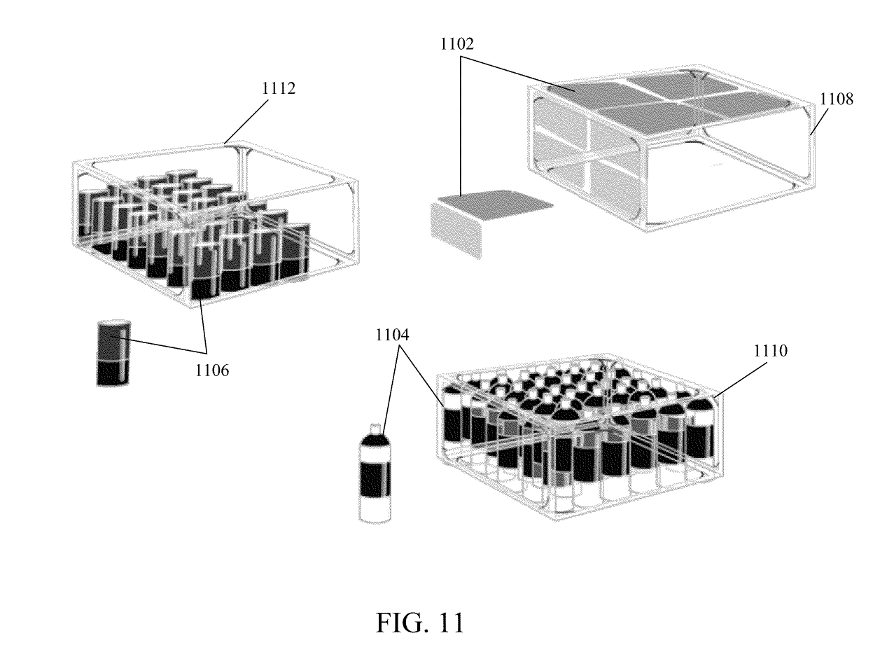

In an embodiment of the present invention, plastic reusable contraptions termed as ‘magazines’ are used to pack food and drinks in modules and these are transported to the aircraft in a thermo regulating apparatus. The ‘magazines are loaded on to the tray carts for serving in the aircraft. FIG. 10 illustrates a magazine, in accordance with an embodiment of the present invention. By using pre packaged refreshments stored in the ‘magazines’ the weight onboard is considerably reduced. FIG. 11 illustrates a modular packing of food and drinks, in accordance with an embodiment of the present invention. Illustrated is the modular packing of various food 1102, water 1104 and beverages 1106 in the new modular packing in magazines 1108, 1110 and 1112 respectively.

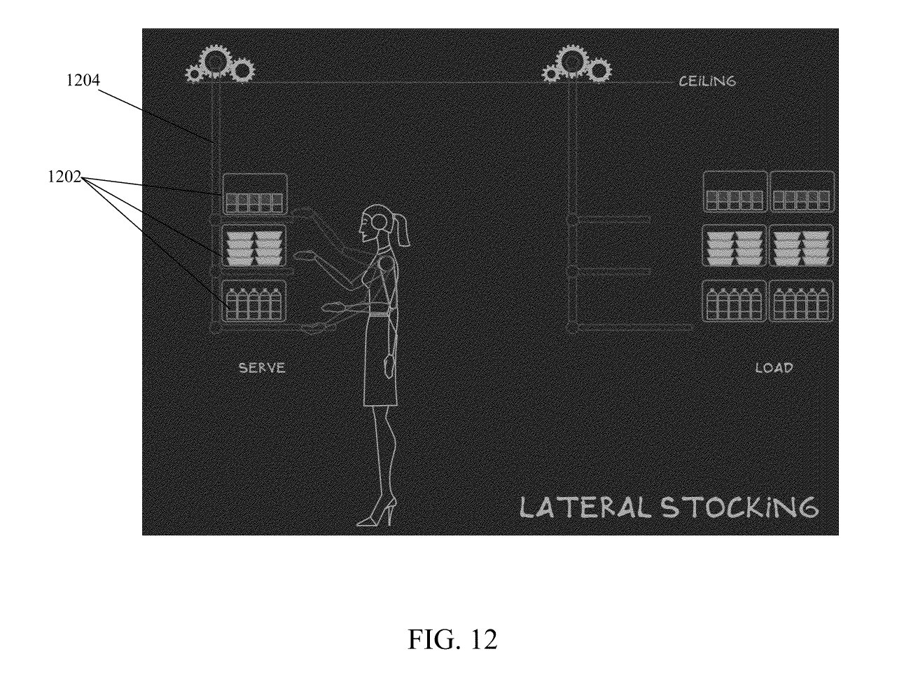

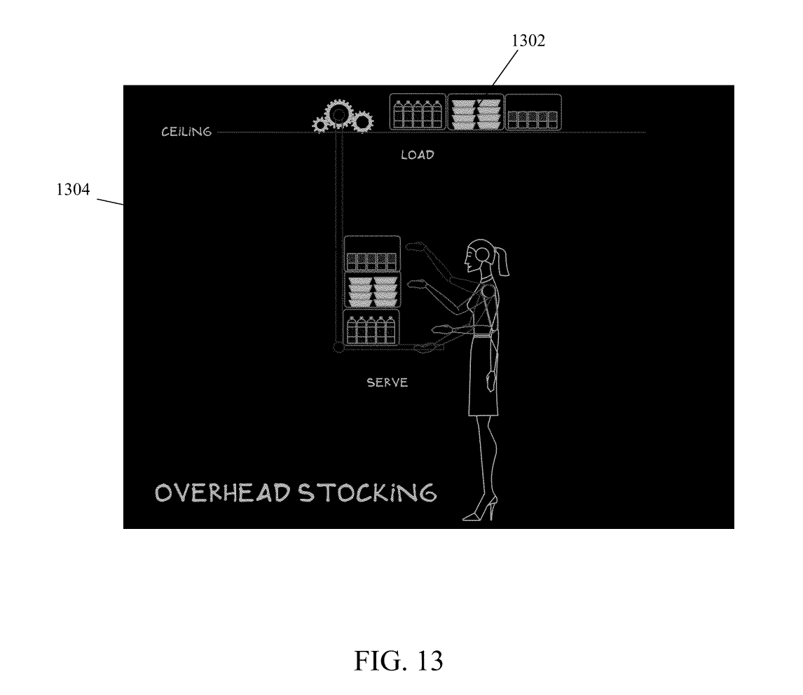

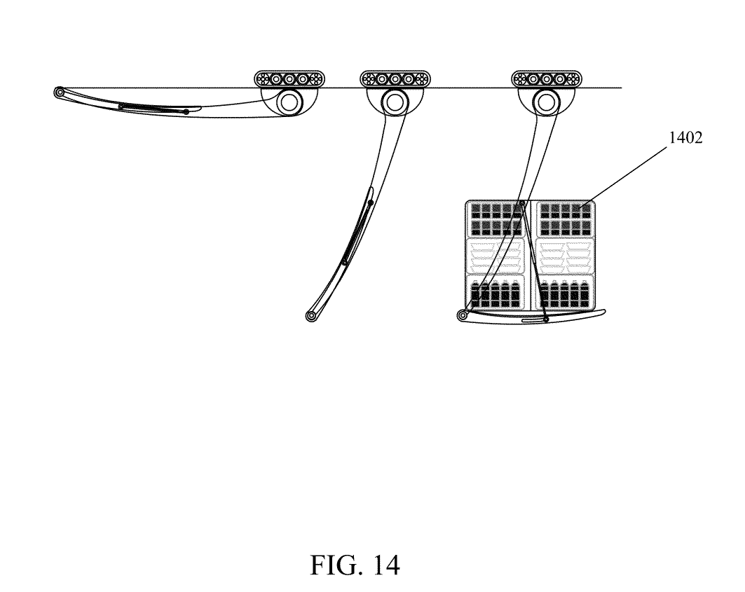

FIG. 12 illustrates a lateral stocking method, in accordance with an embodiment of the present invention. The FIG. illustrates a method of loading of the modular packed Magazines 1202 into the suspended tray cart 1204 from a galley at the rear end of the plane. This is for narrow bodied aircraft where there is no ample crown area to utilize for stocking. FIG. 13 illustrates an overhead stocking method, in accordance with an embodiment of the present invention. The loading of the modular packed magazines 1302 into the tray cart 1304 is done in a stocking area in the crown area. The food is picked and brought to the trolley by way of robotic arms and conveyor belts. This is applicable in a wide bodied aircraft. FIG. 14 illustrates a mechanism of retracting and folding the tray cart 1402 into a ceiling of an aircraft, in accordance with an embodiment of the present invention.

In an embodiment, a thermo regulator in the apparatus which maintains the temperature is used to keep the refreshments fresh and ready to consume. The refreshments may be stored in the galley at the rear end or in the crown area above the ceiling space. They are accessed either manually by picking it from the galley area or in a semi automated manner wherein the magazines are carried down to the trolley by way of conveyor belts. Further, in an embodiment, the tray cart is provided with a cash counter/card swiper which can be used to store change for the purchase made. The tray cart is also provided with an audio visual interface on it since it is hoisted to the level of visibility and advertisements or other useful information is displayed thereon.

In various embodiments, the trolley is pulled down and made ready for loading, the preloaded magazines are loaded onto the trolley and locked, the trolley is trailed down the aisle either semi automatically or manually, the trolley is locked in position where the food needs to be served, the storage area is opened and food is dispensed, the storage area is closed and the trolley is trailed down further and once the food is over it is brought back to the rear end of cabin for reloading. The process is repeated and once the food is served the trolley is trailed back to the initial position and retracted into the ceiling.

The tray cart needs supporting articles like magazines and renovated galley to accommodate the magazine modules than the conventional tray cart. These magazines are made of light weight polymers and can be sterilized and reused.

There are multiple advantages of the present invention. First is that the activity of inflight catering can be carried out easily by the cabin crew as the trolley is above their waist level and suspended on automated/semi automated/manual gear systems which makes it easier to move. The food and condiments are stocked above their waist level which means that they don't have to duck down or resort to any uncomfortable poses to pick the food and serve. Second advantage is that by taking away the need for the conventional tray cart we are directly reducing a lot of weight onboard which accounts to the weight of the tray cart. In a flight on an average 45 tray carts preloaded with food are available. A tray cart weight on an average about 12 to 15 kgs. It is made of largely aluminum. Taking of 45 tray carts weight approx 15 kg each would mean that we are reducing 650 kg of dead weight in one shot. It is said that if we reduce 1 kg per head on a flight the airline company can save up to 48,000 liters of aviation fuel in a year.

While the exemplary embodiments of the present invention are described and illustrated herein, it will be appreciated that they are merely illustrative. It will be understood by those skilled in the art that various changes in form and detail may be made therein without departing from or offending the spirit and scope of the invention.

We claim:

1. A tray cart for serving refreshments in an airplane, the tray cart comprising:
a. a load bearing railing coupled with a fuselage portion of the airplane, the railing stretching from a first end of the airplane to a second end over an aisle portion of the airplane; and
b. a trolley for carrying the refreshments, the trolley being suspended from the railing by means of one or more suspension wires, the trolley being slidable over the railing by means of one or more geared wheels.

2. The tray cart as claimed in claim 1 wherein the trolley is suspended to a predetermined distance above a floor of the aisle portion of the airplane, the suspension length permitting removal of the refreshments placed in the trolley by an attendant without having to bend down.

3. The tray cart as claimed in claim 1 wherein the trolley is slidable over the railing from the first end of the airplane to the second end and from the second end of the airplane to the first end.

4. The tray cart as claimed in claim 1 wherein the trolley comprises:
a. at least one locking means for locking the trolley in a desired position on the railing; and
b. a releasing means for releasing the trolley from the locked position.

5. The tray cart as claimed in claim 1 further comprising a motor and gear system for enabling sliding of the trolley over the railing, the motor and gear system being concealed within a ceiling of the airplane, the motor and gear system being controlled by controlling means provided on a side of the trolley.

6. The tray cart as claimed in claim 1 wherein the trolley comprises one or more pneumatic suspension means for retracting the trolley into a storage position in a ceiling of a rear end of the airplane.

7. The tray cart as claimed in claim 1 wherein the trolley comprises one or more pneumatic suspension means for recovering the trolley from a storage position in a ceiling of the airplane.

8. The tray cart as claimed in claim 1 wherein the trolley comprises one or more shelves for carrying the refreshments.

9. The tray cart as claimed in claim 1 wherein the trolley comprises an audio visual interface and a billing counter.

10. The tray cart as claimed in claim 1 wherein the trolley comprises means for controlling a speed of sliding of the trolley over the railing.

11. The tray cart as claimed in claim 1 wherein the refreshments comprises magazines of prepackaged food and drink, the magazines being designed to fit into the trolley.

12. The tray cart as claimed in claim 1 wherein the refreshments are loaded onto the trolley by using a conveyor belt and robotic arms.
